(19) United States
(12) Patent Application Publication
(10) Pub. No.: US 2022/0273035 A1
(43) Pub. Date: Sep. 1, 2022

(54) SEAL MEMBER, SEAL ASSEMBLY, ELECTRONIC VAPORIZATION DEVICE, AND METHOD FOR MOUNTING SEAL MEMBER

(71) Applicant: SHENZHEN SMOORE TECHNOLOGY LIMITED, Shenzhen (CN)

(72) Inventors: Gaoren YAO, Shenzhen (CN); Songkai CHEN, Shenzhen (CN)

(21) Appl. No.: 17/733,156

(22) Filed: Apr. 29, 2022

Related U.S. Application Data
(63) Continuation of application No. PCT/CN2020/121505, filed on Oct. 16, 2020.

(30) Foreign Application Priority Data
Nov. 19, 2019 (CN) 201911132384.1

(51) Int. Cl. A24F 40/42; A24F 40/485; A24F 40/51

(52) U.S. Cl. CPC A24F 40/42; A24F 40/485; A24F 40/51

(57) ABSTRACT

A seal member for sealing a structural member in an electronic vaporization device includes: a main body portion for attachment to the structural member so as to provide a sealing function; and a traction portion connected to the main body portion so as to pull the seal member such that the main body portion is attached to the structural member.

### CROSS-REFERENCE TO PRIOR APPLICATION

This application is a continuation of International Patent Application No. PCT/CN2020/121505, filed on Oct. 16, 2020, which claims priority to Chinese Patent Application No. CN 201911132384.1, filed on Nov. 19, 2019. The entire disclosure of both applications is hereby incorporated by reference herein.

### FIELD

This application relates to the field of electronic vaporization devices and mounting method technologies, and in particular, to a seal member, a seal assembly, an electronic vaporization device, and a method for mounting the seal member.

### BACKGROUND

In the related art, an electronic vaporization device mainly includes a vaporizer and a power supply device. The vaporizer heats and vaporizes a vapor generation substrate to form vapor that can be inhaled by an inhaler, and the power supply device is configured to supply power to the vaporizer. The vaporizer generally further includes a vaporization base configured to support a vaporization element, so that the vaporization element, an airflow channel, and a liquid storage cavity are suitably configured in the vaporizer to ensure smooth work. Because communication or conduction of air and liquid is involved, a seal member is generally required to be mounted between different components to perform sealing and isolation, which on one hand avoids poor inhalation experience caused by liquid leakage or air leakage, and on the other hand prevents some components such as a power supply, a printed circuit board (PCB), and a pneumatic switch from being corroded by liquid and affecting a service life of the electronic vaporization device. If the seal member is intended to achieve a good sealing and isolation effect, the seal member needs to closely fit with other components and may even need to be pressed. However, the existing electronic vaporization device has a compact structure and a complex component structure that needs to be isolated or sealed, and how to mount the seal member well to enable the seal member to achieve a good sealing and isolation effect becomes a problem to be urgently resolved.

### SUMMARY

In an embodiment, the present invention provides a seal member for sealing a structural member in an electronic vaporization device, comprising: a main body portion configured to be attached to the structural member so as to provide a sealing function; and a traction portion connected to the main body portion and configured to pull the seal member such that the main body portion is attached to the structural member.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic diagram of an overall structure of an electronic vaporization device according to an embodiment.

FIG. 2 is a cross-sectional view of a longitudinal cross section of an electronic vaporization device according to an embodiment.

FIG. 3 is an enlarged view of a region A in FIG. 2.

FIG. 4 is a schematic structural diagram of an electronic vaporization device after a cover body and a housing are hidden according to an embodiment.

FIG. 5 is a schematic structural diagram before a seal member is connected to a holder from a perspective according to an embodiment.

FIG. 6 is a schematic structural diagram after a seal member is connected to a holder from a perspective according to an embodiment.

FIG. 7 is a schematic structural diagram before a seal member is connected to a holder from another perspective according to an embodiment.

FIG. 8 is a schematic structural diagram after a seal member is connected to a holder from another perspective according to an embodiment.

FIG. 9 is a schematic structural diagram after a traction portion of a seal member is partially cut according to an embodiment.

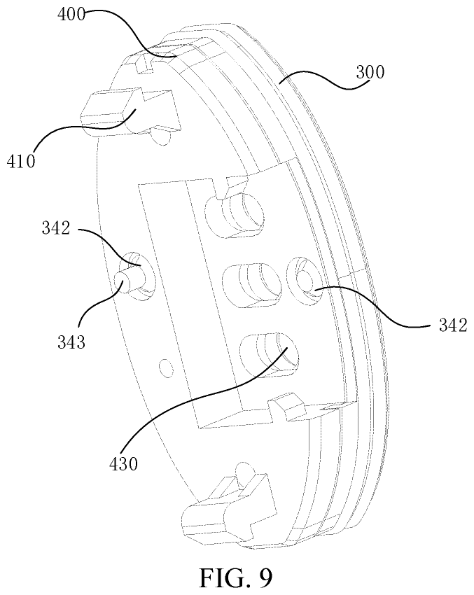

FIG. 10 is a schematic structural diagram of a seal member according to another embodiment.

FIG. 11 is a schematic structural diagram of a seal member according to still another embodiment.

### DETAILED DESCRIPTION

In an embodiment, the present invention provides a seal member, configured to seal a structural member in an electronic vaporization device, and the seal member including:

a main body portion, configured to be attached to the structural member, to achieve a sealing function; and

a traction portion, connected to the main body portion, where the traction portion is configured to pull the seal member, so that the main body portion is attached to the structural member.

In an embodiment, the traction portion is entirely removable or partially removable.

This application further provides a seal assembly, including the seal member and a structural member, where a through hole is provided on the structural member, and the traction portion is configured to pull the seal member through the through hole, so that the main body portion is attached to the structural member.

In an embodiment, the traction portion includes a first via portion, a block portion, and a second via portion, the block portion is located between the first via portion and the second via portion, the main body portion is configured to be attached to one surface of the structural member, and the block portion is configured to be attached to the other surface of the structural member.

In an embodiment, the second via portion is entirely removable or partially removable.

In an embodiment, the second via portion is entirely removable, and the second via portion and the block portion are connected through a breakable structure.

In an embodiment, the second via portion is partially removable, the second via portion includes a reserved portion and a removed portion, the reserved portion and the removed portion are connected through a breakable structure, and the removed portion is located on one end of the second via portion away from the block portion.

In an embodiment, the breakable structure is in a shape of a dumbbell, a size of a middle portion is less than a size of two ends of the breakable structure, and when a pulling force reaches a certain critical force, the breakable structure is pulled off from the middle portion.

In an embodiment, the block portion is elastic, a size of one end of the block portion close to the main body portion is greater than a size of one end away from the main body portion, and a maximum size of the block portion in a radial direction of the through hole is greater than an outer diameter of the through hole.

This application further provides an electronic vaporization device, including a vaporization core, a vaporization base, a holder, and the seal member, where the vaporization core is configured to heat and vaporize a vapor generation substrate; the vaporization base is provided with an electrode, and configured to be electrically connected to the vaporization core; the holder is configured to support and fix the vaporization base; and the structural member is the holder, and the seal member is disposed between the vaporization base and the holder.

In an embodiment, the electronic vaporization device further includes a pneumatic switch and a printed circuit board (PCB), where one end of the holder away from the vaporization base is further configured to support and fix the pneumatic switch and the PCB.

In an embodiment, an airflow channel is further provided inside the electronic vaporization device, a vaporization cavity is formed between the vaporization core and the vaporization base, and the vaporization cavity is in communication with the airflow channel.

In an embodiment, the electronic vaporization device includes a housing and a cover body that are connected to each other, the airflow channel is provided in the housing, the airflow channel includes an air inlet channel and an air outlet channel, an air inlet is provided at a junction of the cover body and the housing, an air outlet is provided at one end of the cover body away from the housing, and the air inlet, the vaporization cavity, and the air outlet are all in communication with the airflow channel.

In an embodiment, the electronic vaporization device further includes a power supply, where a first protrusion and a second protrusion are further provided on a surface of the holder attached to the seal member, the first protrusion and the second protrusion both protrude from the surface of the holder in a direction toward the seal member, a magnetic groove is provided both in the first protrusion and the second protrusion, holes are provided at positions corresponding to the first protrusion and the second protrusion on the seal member, the magnetic grooves and the holes are all configured to place magnetic members, and the magnetic member is configured to connect the vaporization base to the power supply.

In an embodiment, a third protrusion is further provided on the surface of the holder attached to the seal member, the third protrusion protrudes from the surface of the holder in the direction toward the seal member, a microphone air inlet hole is provided in the third protrusion, and the microphone air inlet hole is in communication with the airflow channel to enable airflow to reach the pneumatic switch.

In an embodiment, an airflow chamber is further provided between positions corresponding to the second protrusion and the third protrusion on the seal member, the magnetic member in the second protrusion is provided with an airflow hole in an axial direction of the magnetic member, the airflow hole is in communication with the airflow channel, one end of the second protrusion close to the third protrusion is provided with a notch, and airflow in the second protrusion flows into the airflow chamber through the notch, and then flows into the microphone air inlet hole.

This application further provides a method for mounting the seal member, including the following steps: attaching the main body portion of the seal member to the structural member with pulling assistance of the traction portion; and entirely removing or partially removing the traction portion after the main body portion is attached to the structural member.

It should be noted that, when a component is referred to as “being fixed to” another component, the component may be directly on the another component, or an intervening component may be present. When a component is considered to be “connected to” another component, the component may be directly connected to the another component, or an intervening component may be present. The terms “inner”, “outer”, “left”, “right”, and similar expressions used in this specification are only for purposes of illustration but not indicate a unique implementation.

This application provides a seal member 300, a seal assembly, an electronic vaporization device, and a method for mounting the seal member 300. The seal member 300 is configured to seal a part that needs to be sealed in the electronic vaporization device.

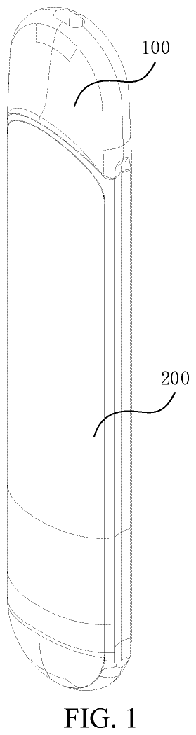

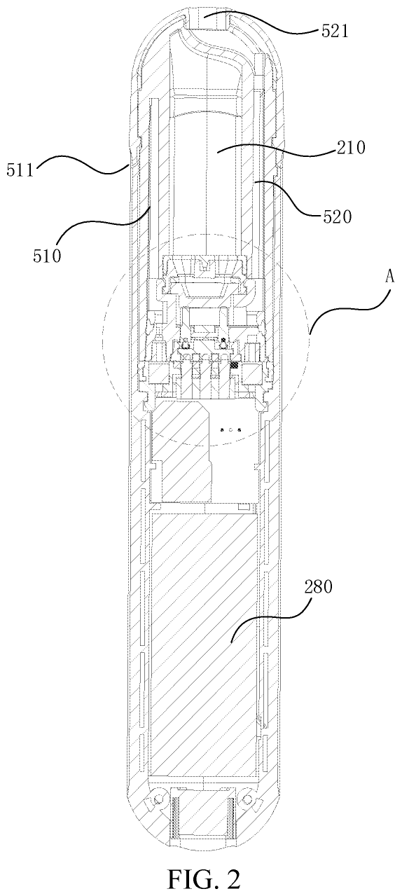

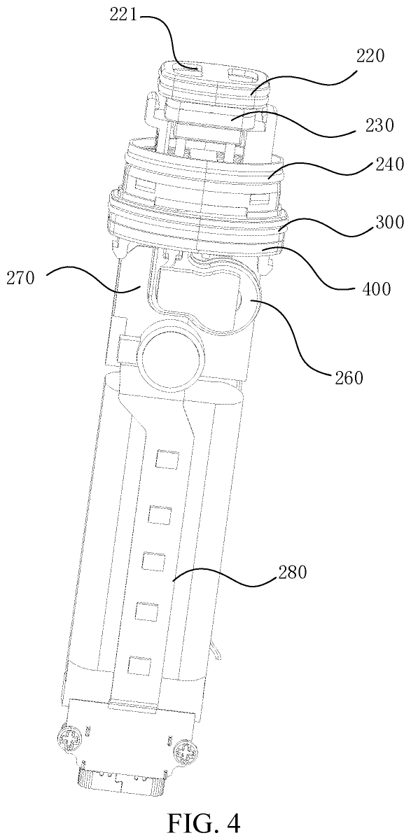

In an embodiment, FIG. 1 shows an overall structure of the electronic vaporization device, and FIG. 2 shows a cross-sectional view of a longitudinal cross section of the electronic vaporization device. As shown in FIG. 1, the electronic vaporization device includes a cover body 100 and a housing 200, and FIG. 4 shows a structure of the electronic vaporization device after the cover body 100 and the housing 200 are hidden.

In an embodiment, the seal assembly includes the seal member 300 and a structural member. In this embodiment, the structural member may be a holder 400.

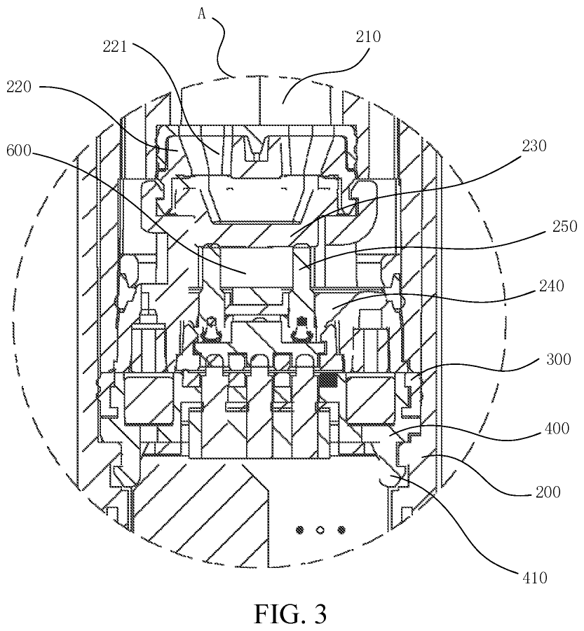

Specifically, as can be seen from FIG. 2 to FIG. 4, in a direction away from the cover body 100, a liquid storage cavity 210, a liquid guide member 220, a vaporization core 230, a vaporization base 240, the seal member 300, the holder 400, a pneumatic switch 260, a printed circuit board (PCB) 270, and a power supply 280 are sequentially disposed in the housing 200. The liquid storage cavity 210 is configured to store vaporizable liquid. A liquid guide hole 221 is provided in the liquid guide member 220, and is configured to guide the vaporizable liquid out to the vaporization core 230. The vaporization core 230 is configured to heat the vaporizable liquid to vaporize the vaporizable liquid. One end of the vaporization core 230 close to the vaporization base 240 is provided with an electrical contact region. One end of the vaporization base 240 is electrically connected to the power supply 280, the other end is provided with an electrode 250, and the electrode 250 is configured to be electrically connected to the electrical contact region of the vaporization core 230, so that the vaporization base 240 can supply power to the vaporization core 230. As shown in FIG. 3, a hook 410 is disposed on the holder 400, and the holder 400 can be fixed to an inner wall of the housing 200 through the hook 410 in a clamped manner. On one hand, the holder 400 is configured to fix and support the vaporization base 240 to enable the vaporization base 240 to be electrically connected to the vaporization core 230, and on the other hand, the holder 400 is further configured to support and fix the pneumatic switch 260 and the PCB 270. The seal member 300 is disposed between the holder 400 and the vaporization base 240, and is configured to prevent the vaporizable liquid from leaking to the pneumatic switch 260 and the PCB 270.

As shown in FIG. 2 and FIG. 3, an airflow channel is further provided in the housing 200, and the pneumatic switch 260 is disposed in the airflow channel. The airflow channel includes an air inlet channel 510 and an air outlet channel 520, an air inlet 511 is provided at a junction of the cover body 100 and the housing 200, an air outlet 521 is provided at one end of the cover body 100 away from the housing 200, a vaporization cavity 600 is formed between the vaporization core 230 and the vaporization base 240, and the air inlet 511, the vaporization cavity 600, and the air outlet 521 are all in communication with the airflow channel. In a specific embodiment, the electronic vaporization device is a vaporization e-cigarette, the vaporization core 230 is a porous ceramic heating component, and the vaporizable liquid is e-liquid. When a user inhales, airflow enters the air inlet channel 510 through the air inlet 511 to trigger the pneumatic switch 260 to work, the vaporization core 230 generates heat to vaporize the vaporizable liquid, and the airflow brings vaporized air out through the air outlet channel 520 and the air outlet 521 for the user to inhale.

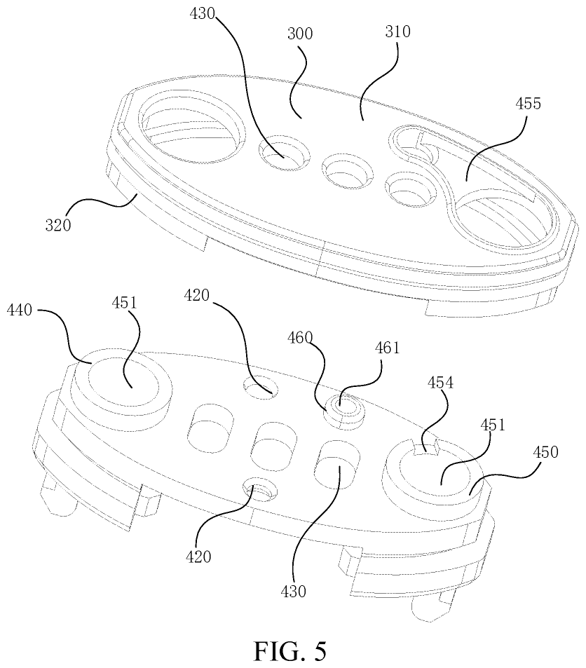

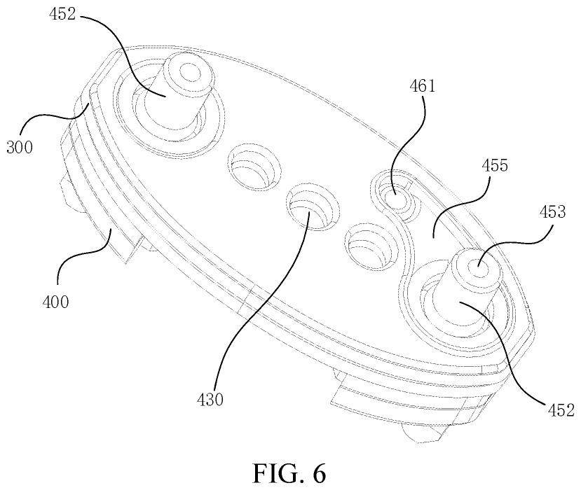

In an embodiment, FIG. 5 shows a structure before the seal member 300 and the holder 400 are connected. A surface of the holder 400 attached to the seal member 300 is uneven, and corresponding positions of the holder 400 and the seal member 300 are both provided with an electrode penetrating hole 430 for the electrode to pass through. In addition, two sides of the surface of the holder 400 attached to the seal member 300 are further provided with a first protrusion 440 and a second protrusion 450 respectively, and a third protrusion 460 is further provided at a position close to the second protrusion 450. A Magnetic groove 451 is provided in both the first protrusion 440 and the second protrusion 450, a microphone air inlet hole 461 is provided in the third protrusion 460, and the microphone air inlet hole 461 is in communication with the airflow channel in the electronic vaporization device to enable the airflow to reach the pneumatic switch 260. Positions corresponding to the first protrusion 440, the second protrusion 450, and the third protrusion 460 on the seal member 300 are all provided with a hole. As shown in FIG. 5 and FIG. 6, the magnetic grooves 451 and the holes corresponding to the first protrusion 440 and the second protrusion 450 on the seal member 300 are configured to place magnetic members 452, and the magnetic member 452 is configured to connect the vaporization base 240 to components such as the power supply 280 at the bottom of the housing 200.

In addition, as shown in FIG. 5 and FIG. 6, an airflow chamber 455 is further provided between positions corresponding to the second protrusion 450 and the third protrusion 460 on the seal member 300. The magnetic member 452 in the second protrusion 450 is provided with an airflow hole 453 in an axial direction of the magnetic member, and the airflow hole 453 is in communication with the airflow channel in the electronic vaporization device, so that the airflow in the airflow channel can flow into the magnetic groove 451 in the second protrusion 450 through the airflow hole 453. One end of the second protrusion 450 close to the third protrusion 460 is provided with a notch 454, and the airflow in the second protrusion 450 can flow into the airflow chamber 455 on the seal member 300 through the notch 454, and then flow into the microphone air inlet hole 461 in the third protrusion 460 through the airflow chamber 455 on the seal member 300, so that the airflow can reach the pneumatic switch 260. The first protrusion 440, the second protrusion 450, and the third protrusion 460 on the holder 400 all protrude from a surface of the holder 400 in a direction toward the seal member 300, and are configured to prevent condensed liquid from flowing into the magnetic groove 451 or the microphone air inlet hole 461 located inside.

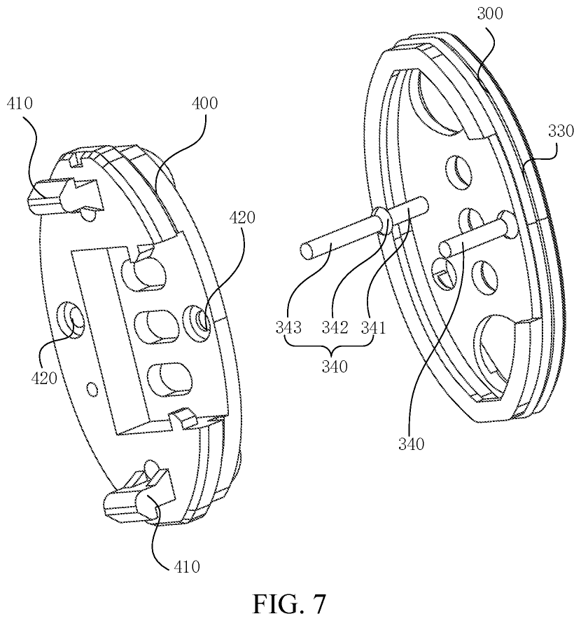

In addition, as shown in FIG. 7, the seal member 300 is made of an elastic material such as silica gel, and the seal member 300 includes a main body portion 330 and two traction portions 340 that are connected to each other. The main body portion 330 is configured to be attached to the holder 400, to achieve a sealing function, and the traction portion 340 is configured to pull the seal member 300 to enable the main body portion 330 to be attached to the holder 400. As shown in FIG. 5, the main body portion 330 includes a plane portion 310 and a side portion 320, where the plane portion 310 can perform plane attachment with the holder 400, and the side portion 320 can cover a peripheral side of the holder 400 to perform curve attachment with the holder 400. As shown in FIG. 7, a through hole 420 is provided on the holder 400. The traction portion 340 includes a first via portion 341, a block portion 342, and a second via portion 343, where the block portion 342 is located between the first via portion 341 and the second via portion 343, a size of one end of the block portion 342 close to the main body portion 330 is greater than a size of one end away from the main body portion 330, and a maximum size of the block portion 342 in a radial direction of the through hole 420 is greater than an outer diameter of the through hole 420. During mounting, the traction portion 340 can pull the seal member 300 through the through hole 420, and the block portion 342 is first elastically pressed when passing through the through hole 420, and then elastically released after passing the through hole 420. FIG. 6 shows a structure after the seal member 300 is connected to the holder 400. The main body portion 330 of the seal member 300 is attached to one surface of the holder 400, and the block portion 342 is attached to the other surface of the holder 400, so that after the pulling force is removed, the seal member 300 can be still tightly attached to the holder 400. After the seal member 300 is connected to the holder 400, according to a specific situation, the second via portion 343 can be entirely removed or partially removed, to prevent the traction portion 340 from interfering with mounting of subsequent members. As shown in FIG. 7, the second via portion 343 of one of the traction portions 340 is partially removed, and the second via portion 343 of the other of the traction portions 340 is entirely removed. In a specific embodiment, a specific removing manner may be cutting off or another removing method.

It should be noted that, in the embodiment shown in FIG. 7, after the seal member 300 is tightly attached to the holder 400, the second via portion 343 of one of the traction portions 340 is partially removed, and the second via portion 343 of the other of the traction portions 340 is entirely removed. It may be understood that, in other embodiments, the entire length of the traction portion 340 is relatively short, and after the seal member 300 is tightly attached to the holder 400, the length of the second via portion 343 is relatively short, which may not affect the mounting of subsequent members. In this case, the seal member 300 and the second via portion 343 thereof may alternatively not be removed.

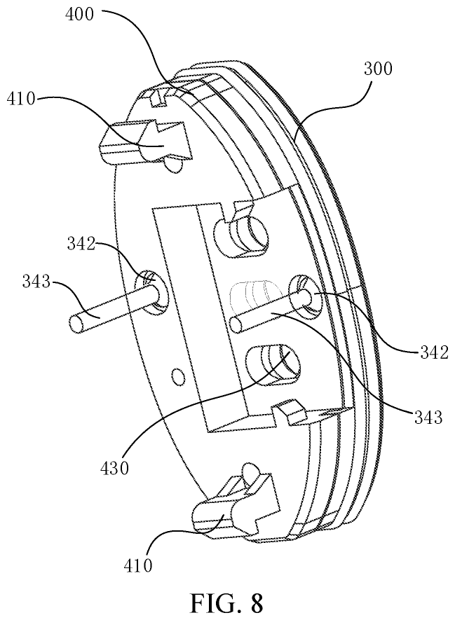

In the embodiments shown in FIG. 7 and FIG. 8, the seal member 300 includes two traction portions 340. It may be understood that, the quantity of the traction portions 340 is not limited in this application. In other embodiments, it may be understood that, there may be one or more than two traction portions 340. In addition, in the embodiments shown in FIG. 2 to FIG. 4, the seal member 300 is disposed between the vaporization base 240 and the holder 400. It may be understood that, in other embodiments, the seal member 300 may be alternatively attached to any structural member that needs to be sealed or isolated in the electronic vaporization device for sealing or isolation, to prevent liquid leakage or air leakage, or prevent some components such as the power supply 280, the PCB 270, and the pneumatic switch 260 from being corroded by liquid such as the vaporizable liquid or the condensed liquid.

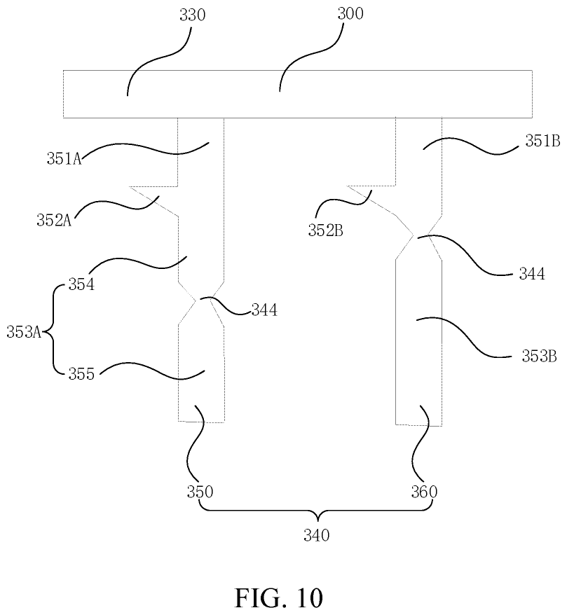

In addition, in an embodiment, after the seal member 300 is attached to the structural member that needs to be sealed or isolated in the electronic vaporization device, for ease of removing the second via portion 343, a breakable structure 344 is further provided on the traction portion 340 of the seal member 300. In a specific embodiment, as shown in FIG. 10, the seal member 300 includes a first traction portion 350 and a second traction portion 360, where the first traction portion 350 includes a first via portion 351A, a block portion 352A, and a second via portion 353A, and the second traction portion 360 includes a first via portion 351B, a block portion 352B, and a second via portion 353B. The second via portion 353A of the first traction portion 350 includes a reserved portion 354 and a removed portion 355, the reserved portion 354 and the removed portion 355 are connected through the breakable structure 344, and the second via portion 353B and the block portion 352B of the second traction portion 360 are connected through the breakable structure 344. The breakable structure 344 is in a shape of a dumbbell, a size of a middle portion of the breakable structure 344 is less than a size of two ends, and when the pulling force reaches a certain critical force, the breakable structure 344 can be pulled off from the middle portion. It should be noted that, the traction portion 340 of the seal member 300 is pulled, so that the main body portion 330 of the seal member 300 is tightly attached to the holder 400 or a pulling force of another structural member is far less than the critical force for pulling off the breakable structure 344. In addition, the length of the reserved portion 354 of the first traction portion 350 is relatively short, which may not affect the mounting of subsequent members. A function of disposing the reserved portion 354 is to provide an operating space. After the seal member 300 is attached to the holder 400 or another structural member that needs to be sealed or isolated, an operator can hold the reserved portion 354 and the removed portion 355, to apply pulling forces in opposite directions to the reserved portion 354 and the removed portion 355 respectively. As a result, the middle portion of the breakable structure 344 is pulled off, the removed portion 355 is detached from the seal member 300, and in the process that the breakable structure 344 is pulled off, no pulling force is generated to other parts of the seal member 300, thereby preventing an excessively great pulling force from affecting sealing functions of other parts of the seal member 300.

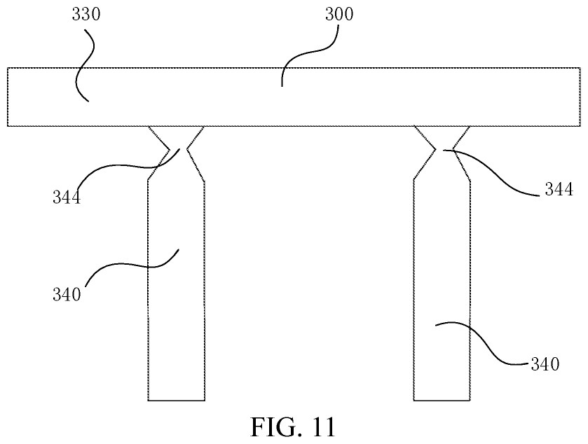

In addition, it may be understood that, in other embodiments, the block portion 342 may alternatively not be provided on the traction portion 340 of the seal member 300. After the seal member 300 is tightly attached to the holder 400 or the another structural member, the vaporization base 240 is disposed above the seal member 300, so that the seal member 300 is tightly pressed or disposed between the vaporization base 240 and the holder 400, and the traction portion 340 then may be entirely removed. In an embodiment, as shown in FIG. 11, the breakable structure 344 is disposed between one end of the traction portion 340 close to the main body portion 330 and the main body portion 330. After the seal member 300 is tightly pressed or disposed between the vaporization base 240 and the holder 400, the traction portion 340 is pulled forcefully, so that the traction portion 340 is entirely removed. After the traction portion 340 is entirely removed, the interference from the traction portion 340 in the mounting of subsequent members can be completely avoided.

This application further provides a method for mounting the seal member 300, including the following steps:

S100: Attach the main body portion 330 of the seal member 300 to the structural member with pulling assistance of the traction portion 340; and

S200: Entirely remove or partially remove the traction portion 340 after the main body portion 330 is attached to the structural member.

According to the seal member 300, the seal assembly, the electronic vaporization device, and the method for mounting the seal member 300 of this application, by disposing the traction portion 340 configured to pull the seal member 300 and assisting in attachment for sealing on the seal member 300, the main body portion 330 of the seal member 300 can be tightly attached to the structural member in the electronic vaporization device, to achieve a good sealing effect. After the main body portion 330 of the seal member 300 is attached to the structural member in the electronic vaporization device for sealing, the traction portion 340 can further be removed, and may not interfere with the mounting of subsequent members in the electronic vaporization device.

The technical features in the foregoing embodiments may be randomly combined. For concise description, not all possible combinations of the technical features in the embodiments are described. However, provided that combinations of the technical features do not conflict with each other, the combinations of the technical features are considered as falling within the scope described in this specification.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMERALS

cover body 100

housing 200

liquid storage cavity 210

liquid guide member 220

liquid guide hole 221

vaporization core 230

vaporization base 240

electrode 250

seal member 300

plane portion 310

side portion 320

main body portion 330

traction portion 340

first via portion 341

block portion 342

second via portion 343

breakable structure 344

first traction portion 350

first via portion 351A of the first traction portion 350

block portion 352A of the first traction portion 350

second via portion 353A of the first traction portion 350

second traction portion 360

first via portion 351B of the second traction portion 360

block portion 352B of the second traction portion 360

second via portion 353B of the second traction portion 360

reserved portion 354

removed portion 355

holder 400

hook 410

through hole 420

electrode penetrating hole 430

first protrusion 440

second protrusion 450

third protrusion 460

magnetic groove 451

magnetic member 452

airflow hole 453

notch 454

airflow chamber 455

microphone air inlet hole 461

pneumatic switch 260

PCB 270

power supply 280

air inlet channel 510

air outlet channel 520

air inlet 511

air outlet 521

vaporization cavity 600

What is claimed is:

1. A seal member for sealing a structural member in an electronic vaporization device, comprising:
a main body portion configured to be attached to the structural member so as to provide a sealing function; and
a traction portion connected to the main body portion and configured to pull the seal member such that the main body portion is attached to the structural member.

2. The seal member of claim 1, wherein the traction portion is entirely removable or partially removable.

3. A seal assembly, comprising:
the seal member of claim 1; and
the structural member,
wherein a through hole is provided on the structural member, and
wherein the traction portion is configured to pull the seal member through the through hole such that the main body portion is attached to the structural member.

4. The seal assembly of claim 3, wherein the traction portion comprises a first via portion, a block portion, and a second via portion, the block portion being located between the first via portion and the second via portion,
wherein the main body portion is configured to be attached to one surface of the structural member, and
wherein the block portion is configured to be attached to an other surface of the structural member.

5. The seal assembly of claim 4, wherein the second via portion is entirely removable or partially removable.

6. The seal assembly of claim 5, wherein the second via portion is entirely removable, and
wherein the second via portion and the block portion are connected through a breakable structure.

7. The seal assembly of claim 5, wherein the second via portion is partially removable,
wherein the second via portion comprises a reserved portion and a removed portion, the reserved portion and the removed portion being connected through a breakable structure, and
wherein the removed portion is located on one end of the second via portion away from the block portion.

8. The seal assembly of claim 6, wherein the breakable structure is in a shape of a dumbbell,
wherein a size of a middle portion is less than a size of two ends of the breakable structure, and
wherein, when a pulling force reaches a certain critical force, the breakable structure is configured to be pulled off from the middle portion.

9. The seal assembly of claim 4, wherein the block portion is elastic,
wherein a size of one end of the block portion close to the main body portion is greater than a size of one end away from the main body portion, and
wherein a maximum size of the block portion in a radial direction of the through hole is greater than an outer diameter of the through hole.

10. An electronic vaporization device, comprising:
a vaporization core configured to heat and vaporize a vapor generation substrate;
a vaporization base comprising an electrode, the vaporization base being electrically connectable to the vaporization core;
a holder configured to support and fix the vaporization base; and
the seal member of claim 1,
wherein the structural member comprises the holder, and
wherein the seal member is disposed between the vaporization base and the holder.

11. The electronic vaporization device of claim 10, further comprising:
a pneumatic switch; and
a printed circuit board (PCB),
wherein one end of the holder away from the vaporization base is configured to support and fix the pneumatic switch and the PCB.

12. The electronic vaporization device of claim 11, wherein an airflow channel is provided inside the electronic vaporization device,
wherein a vaporization cavity is formed between the vaporization core and the vaporization base, and
wherein the vaporization cavity is in communication with the airflow channel.

13. The electronic vaporization device of claim 12, wherein the electronic vaporization device comprises a housing and a cover body that are connected to each other,
wherein the airflow channel is provided in the housing,
wherein the airflow channel comprises an air inlet channel and an air outlet channel,
wherein an air inlet is provided at a junction of the cover body and the housing,
wherein an air outlet is provided at one end of the cover body away from the housing, and
wherein the air inlet, the vaporization cavity, and the air outlet are all in communication with the airflow channel.

14. The electronic vaporization device of claim 12, further comprising:
a power supply,
wherein a first protrusion and a second protrusion are further provided on a surface of the holder attached to the seal member, the first protrusion and the second protrusion both protruding from the surface of the holder in a direction toward the seal member,
wherein a magnetic groove is provided both in the first protrusion and the second protrusion,
wherein holes are provided at positions corresponding to the first protrusion and the second protrusion on the seal member,
wherein the magnetic grooves and the holes are all configured to place magnetic members, and
wherein the magnetic member is configured to connect the vaporization base to the power supply.

15. The electronic vaporization device of claim 14, wherein a third protrusion is further provided on the surface of the holder attached to the seal member, the third protrusion protruding from the surface of the holder in the direction toward the seal member,
wherein a microphone air inlet hole is provided in the third protrusion, and
wherein the microphone air inlet hole is in communication with the airflow channel so as to enable airflow to reach the pneumatic switch.

16. The electronic vaporization device of claim 15, wherein an airflow chamber is further provided between positions corresponding to the second protrusion and the third protrusion on the seal member,
wherein the magnetic member in the second protrusion is provided with an airflow hole in an axial direction of the magnetic member, the airflow hole being in communication with the airflow channel, and
wherein one end of the second protrusion close to the third protrusion is provided with a notch configured to flow the airflow from the second protrusion into the airflow chamber through the notch and then into the microphone air inlet hole.

17. A method for mounting the seal member of claim 1, comprising:
attaching the main body portion of the seal member to the structural member with pulling assistance of the traction portion; and
entirely removing or partially removing the traction portion after the main body portion is attached to the structural member.
